(19) United States
(12) Patent Application Publication
(10) Pub. No.: US 2025/0180491 A1
(43) Pub. Date: Jun. 5, 2025

(54) WIRE ROD, ENAMELED WIRE, AND METHOD FOR MANUFACTURING ENAMELED WIRE

(71) Applicant: Proterial, Ltd., Tokyo (JP)

(72) Inventors: Hajime NISHI, Tokyo (JP); Yuki HONDA, Tokyo (JP); Kazufumi SUENAGA, Tokyo (JP)

(21) Appl. No.: 18/829,984

(22) Filed: Sep. 10, 2024

(30) Foreign Application Priority Data
Nov. 30, 2023 (JP) 2023-202483

(51) Int. Cl. G01N 21/952; G01N 21/65; G01N 21/84; H01B 3/30; H01B 13/06

(52) U.S. Cl. CPC G01N 21/952; G01N 21/65; G01N 21/8422; H01B 13/065; G01N 2021/8427; H01B 3/306

(57) ABSTRACT

A wire rod is mainly composed of copper, and an oxidation degree measured on a surface of the wire rod using Raman spectral analysis is less than 25, in which measurement of the oxidation degree is performed by mapping Raman spectra under conditions described below, a histogram is created from peak areas of Raman spectral peaks in respective pixels of an obtained mapping image, an average value of a plurality of the peak areas is determined from the histogram, and the average value is measured as the oxidation degree, and a plurality of the Raman spectral peaks are peaks attributed to a lattice vibration of a vibrational mode 2Eᵤ of Cu₂O, the histogram has a horizontal axis representing 256 levels into which a range from minimum to maximum of the plurality of the peak areas are divided, and a vertical axis representing a frequency, which is a number of pixels in each level.

### CROSS-REFERENCE TO RELATED APPLICATIONS

The present patent application claims the priority of Japanese patent application No. 2023-202483 filed on Nov. 30, 2023, the entire contents of which are incorporated herein by reference.

### TECHNICAL FIELD

This disclosure relates to a wire rod, an enameled wire, and a method for manufacturing the enameled wire.

### BACKGROUND OF THE INVENTION

Conventionally, a widely known method for manufacturing an enameled wire is to form an enameled film made of polyimide or polyamideimide on the surface of a wire conductor (see Patent Literature 1, for example).

In general, a wire rod is used as a conductor of an enameled wire in a state called “peeled material,” in which an oxide film on the surface of the wire rod has been peeled off. The purpose of using the peeled material with the oxide film peeled off as a conductor material is to improve adhesion to enamel varnish and to improve the appearance.

### CITATION LIST

Patent Literature 1: Japanese Patent No. 6730930

### SUMMARY OF THE INVENTION

However, the oxidation on the surface of the peeled material restarts immediately after the oxide film is peeled off. Therefore, if storage conditions (temperature, humidity, and time) are not properly controlled, the oxidation on the surface of the peeled material is accelerated and discoloration occurs.

Although the peeled material is subjected to machining processes such as round drawing, rolling, and flat-angle drawing, as well as the enamel coating process, processing lines that perform these processes generally do not include equipment for peeling an oxide film, and there is no process for peeling the surface oxide film from the peeled material again. Therefore, if the peeled material looks discolored due to conductor discoloration, the defective appearance remains even after forming a translucent enamel coating.

According to research by the inventors of the present invention, it is confirmed that a wire rod with oxidation on its surface, such as discolored peeled material, has cracks in the low elongation oxide film during wire drawing due to the embrittlement of the conductor surface caused by oxidation, and the generation of copper particles (wear particles) increases. The inventors also found that copper particles adhering to the surface of the conductor after having drawn a wire rod tend to include microbubbles and that the volume expansion (foaming) of the microbubbles caused by evaporation of solvent during baking after enamel coating results in a defective appearance of enameled wire.

In order to suppress such a defect in the appearance of an enameled wire, the manufacturing process of an enameled wire requires the use of a wire rod with suppressed surface oxidation, such as peeled material with suppressed surface oxidation after the oxide film has been peeled.

The object of the present invention is to provide a wire rod with suppressed surface oxidation that can form a high-quality enameled wire, an enameled wire formed by using the wire rod, and a method for manufacturing the enameled wire.

For solving the above problem, one aspect of the present invention provides a wire rod mainly composed of copper,
wherein oxidation degree measured on a surface of the wire rod using Raman spectral analysis is less than 25,
wherein measurement of the oxidation degree is performed by mapping Raman spectra under conditions described below, a histogram is created from peak areas of Raman spectral peaks in respective pixels of an obtained mapping image, an average value of a plurality of the peak areas is determined from the histogram, and the average value is measured as the oxidation degree,
wherein a plurality of the Raman spectral peaks are peaks attributed to a lattice vibration of a vibrational mode 2Eᵤ of Cu₂O, and
wherein the histogram has a horizontal axis representing 256 levels into which a range from minimum to maximum of the plurality of the peak areas are divided, and a vertical axis representing a frequency, which is a number of pixels in each level,
wherein Raman measurement system is RAMANforce Standard VIS-NIR-HS by Nanophoton, a laser wavelength is 532.06 nm, a width of an incident slit of a spectrometer is 50 μm, a ratio of light intensity after attenuation to maximum laser light intensity of ND filter (attenuation ratio) is 215/255, a number of engraved lines in diffraction grating is 600 gr/mm, a magnification of objective lens is 100×, a numerical aperture (NA) is 0.9, a mapping range is 88×60 μm, and a pixel size is 2×2 μm.

Also, for solving the above problem, another aspect of the present invention provides an enameled wire comprising a conductor made by drawing the wire rod and an insulative coating provided around the conductor.

In addition, for solving the above problem, still another aspect of the present invention provides a method for manufacturing an enameled wire, comprising: mapping Raman spectrum by irradiating a laser beam on a surface of a wire rod mainly composed of copper;
evaluating an oxidation degree on the surface of the wire rod by using an average value of peak areas of peaks obtained by a histogram of the peak areas of the peaks attributed to a lattice vibration of a Cu₂O vibration mode 2Eᵤ in respective pixels of a mapping image obtained by the mapping;
drawing the wire rod after the evaluation; and
forming an insulative coating around a conductor after the drawing, by applying an enamel varnish to a surface of the conductor formed by drawing the wire rod and baking the enamel varnish,
wherein the drawing and the coating forming are performed when a predetermined result is obtained in the evaluation.

### Advantageous Effects of the Invention

According to the present invention, it is possible to provide a wire rod with suppressed surface oxidation that can form a high-quality enameled wire, an enameled wire formed by using the wire rod, and a method for manufacturing the enameled wire.

### BRIEF DESCRIPTION OF DRAWINGS

FIGS. 1A and 1B are examples of photographs showing an external appearance of a peeled material.

FIG. 2 is a cross-sectional view in the radial direction of an enameled wire according to an embodiment.

FIG. 3A is an optical microscope image of the surface of the peeled material.

FIG. 3B is a mapping image obtained by Raman scattering measurement in the measurement range shown in FIG. 3A.

FIG. 4 is an example of Raman spectra obtained from Raman scattering measurements on the surface of the peeled material, showing two Raman spectra measured at the measurement points (center points of crosses) indicated by “1” and “2” in the optical microscope image shown in FIG. 3A.

FIG. 5 shows a histogram of the mapping image including the Raman spectra of FIG. 4.

FIG. 6 is a graph plotting the data from Table 1 with the horizontal axis representing the storage time (h) of the peeled material and the vertical axis representing the oxidation degree.

### DETAILED DESCRIPTION OF EMBODIMENT

### (Features of the Wire Rod)

The wire rod according to the present invention is a wire rod with a suppressed surface oxidation, mainly composed of copper, and is typically a peeled material. A peeled material is a wire rod in a state where an oxide film on the surface has been peeled from a wire rod called “wire rod”. The following is a description of the peeled material according to an embodiment. The peeled material according to the embodiment is referred to as “peeled material 1.” Also, the words “mainly composed of copper” mean, for example, that the concentration of copper is 99.9% or more.

The peeled material 1 used as a conductor of enameled wire is subjected to processes such as round drawing, flat drawing (i.e., rectangular drawing), rolling, and the like, and the formation of an insulative coating on its surface. The oxidation degree on the surface of the peeled material 1 immediately prior to processes such as round drawing, flat angle drawing, rolling, and the like, should be less than 25. The oxidation degree is a parameter obtained by Raman scattering measurement that indicates a degree of oxidation. Details of the oxidation degree are described below. Since the measurement of the oxidation degree for the peeled material 1 described below can also be performed on a wire rod that has not been peeled, the wire rod according to the present invention, including the ones that have not been peeled, can have an oxidation degree of less than 25 on the surface immediately prior to the processes.

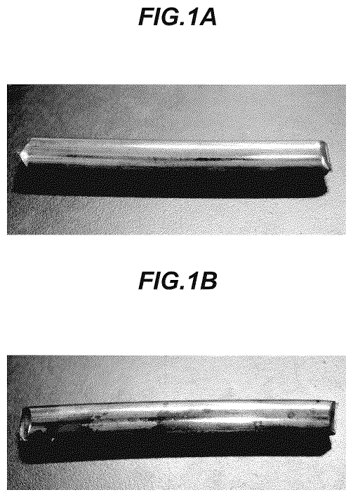

FIGS. 1A and 1B are examples of photographs showing the external appearance of a peeled material. The peeled material shown in FIG. 1A has a surface oxidation degree of 21.84, corresponding to the peeled material 1 according to the embodiment. The peeled material shown in FIG. 1A has little surface discoloration, which indicates that the surface oxidation is suppressed.

On the other hand, the peeled material shown in FIG. 1B has a surface oxidation degree of 102.6, which does not correspond to the peeled material 1 according to the embodiment of the present invention. The peeled material shown in FIG. 1B has some discolored and darkened areas, which indicates that some degree of oxidation has occurred on the surface.

The peeled material 1 can be used as a conductor material for an enameled wire. For example, after drawing the peeled material 1, a polyimide or polyamideimide coating is applied to the surface of the peeled material 1 and baked, thereby producing an enameled wire with an enameled film around the peeled material 1. In other words, according to the embodiment, it is possible to provide an enameled wire with a conductor made of the peeled material 1 and an insulative coating coating around the conductor.

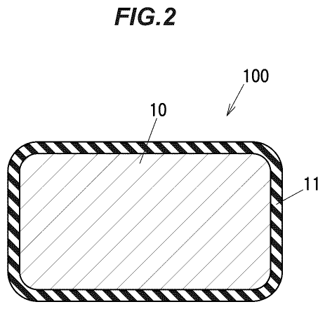

FIG. 2 is a cross-sectional view in the radial direction of an enameled wire 100 according to the embodiment. The enameled wire 100 shown in FIG. 2 is an enameled wire in a rectangular cross-sectional shape, having a conductor 10 in a flat (i.e., rectangular) wire shape formed by drawing a wire rod such as the peeled material 1, and an insulative coating 11 formed around the conductor 10. The enameled wire 100 may have a circular cross-sectional shape. In that case, the conductor 10 is formed in a round shape by drawing a wire rod such as the peeled material 1.

The peeled material shown in FIGS. 1A and 1B is a peeled material with a 6.3 mm diameter and is used as a raw material for a flat (rectangular) enameled wire conductor, which is an 8 mm diameter wire rod after the oxide film on the surface is exfoliated (peeled) and a lubricant is applied. The wire rod used as the raw material is oxygen-free copper (OFC) produced by a dip-forming system manufactured by Showa Electric Wire & Cable System Co. (SWCC Corporation)

The oxidation degree is defined as an average value of peak areas of Cu₂O peaks obtained from a histogram which is created from the peak areas attributed to the lattice vibration of Cu₂O vibration mode 2Eᵤ (hereinafter referred to as the “Cu₂O peak”) in respective pixels of the mapping image obtained by mapping a Raman spectrum with a laser beam on the surface of the peeled material. The histogram has a horizontal axis representing 256 levels into which the range of peak areas from the minimum to the maximum are divided and the vertical axis representing the frequency, which is the number of pixels per level.

The mapping process in the above definition of oxidation degree is performed using a Raman measurement device (RAMANforce Standard VIS-NIR-HS by Nanophoton) under the conditions: the laser wavelength is 532.06 nm, the width of the incident slit of the spectrograph is 50 μm, the ratio of light intensity after attenuation to laser maximum light intensity of an ND filter (attenuation ratio) is 215/255, the number of engraved lines in diffraction grating is 600 gr/mm, the magnification and numerical aperture (NA) of the objective lens are 100× and 0.9 respectively, the mapping area and pixel size are 88×60 μm and 2×2 μm respectively (i.e., the number of pixels in the mapping image is 1320).

As described above, because the oxidation degree on the surface of the peeled material is measured by Raman spectroscopic analysis, which measures Raman scattered light, the oxidation degree on the surface can be evaluated in a non-contact manner without destroying the peeled material. In addition, since the peak areas of the Cu₂O peaks in the Raman spectrum are used in the measurement of the oxidation degree, the oxidation degree on the surface of the peeled material can be evaluated with high accuracy. For example, when analyzing the components of the surface of the peeled material by elemental analysis, it is difficult to accurately evaluate the oxidation degree because information on oxygen other than the oxygen contained in the copper oxide is obtained in a mixed manner.

The specific procedure for measuring the oxidation degree is described below. The procedure for measuring the oxidation degree on the surface of the peeled material according to the embodiment of the present invention includes a process of irradiating a laser beam on the surface of the peeled material and mapping Raman spectra and a process of deriving the oxidation degree on the surface of the peeled material based on peak areas of Cu₂O peaks in a plurality of Raman spectrum obtained by the mapping.

The mapping process here is a process in which a measurement is repeated while scanning measurement points (laser irradiation points) within a predetermined measurement area on the surface of an object to be measured. The mapping image, which is two-dimensional measurement data obtained by the mapping process, has the data per pixel of the peak areas of the Cu₂O peaks in a Raman spectrum obtained by a single Raman scattering measurement. The spot diameter of the laser beam irradiated on the surface of the peeled material in the Raman scattering measurement is, for example, 0.4 μm to 2.2 μm.

Since the peak areas of the Cu₂O peaks in the Raman spectrum vary with the amount of oxide on the surface of the peeled material, the peak areas of the Cu₂O peaks are factors for evaluating the oxidation degree of the peeled material surface.

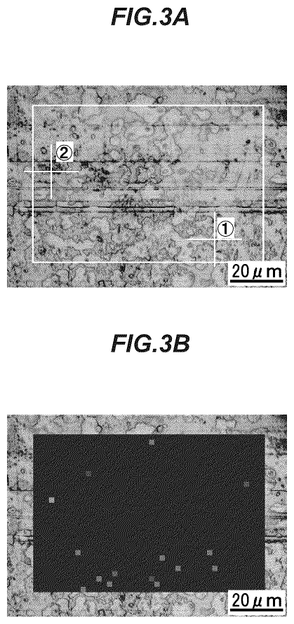

FIG. 3A is an optical microscope image of the surface of the peeled material. The rectangular frame in this optical microscope image indicates the measurement range of Raman scattering measurement. FIG. 3B shows the mapping image obtained by the Raman scattering measurement in the measurement range shown in FIG. 3A. The size of the measurement range shown in FIG. 3A and that of the mapping image shown in FIG. 3B are 88×60 μm, and the size of one pixel of the mapping image is 2 μm×2 μm. Each pixel of the mapping image contains data on the intensity of the peak attributed to the lattice vibration of the Cu₂O vibration mode 2Eᵤ (Cu₂O peak).

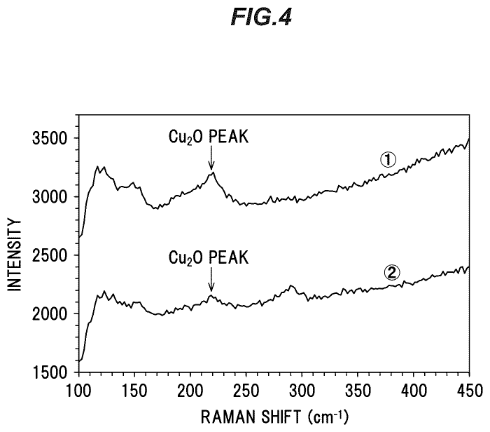

FIG. 4 shows an example of Raman spectra obtained from Raman scattering measurements on the surface of the peeled material performed under the conditions described above, showing two Raman spectra measured at the measurement points indicated by “1” and “2” (center points of the crosses) in the optical microscope image shown in FIG. 3A. This Raman spectrum contains the Cu₂O peaks. Each pixel in the mapping image shown in FIG. 3B has a color intensity corresponding to the intensity of the Cu₂O peak measured at that pixel.

The Cu₂O peak takes its maximum intensity in the Raman spectrum in the vicinity of 220 cm⁻¹, in the range of 190 cm⁻¹ or more and 250 cm⁻¹ or less. The wavenumber at which the maximum intensity of each peak in the Raman spectrum is measured can be shifted depending on the environmental temperature at the time of measurement or the like. However, the size relationship of wavenumbers at which the peaks have maximum intensities does not change, so there is no misidentification.

The peak areas of the Cu₂O peaks in the present embodiment are calculated using the Covell method. The range of wavenumbers over which the peak areas of the Cu₂O peaks are measured is manually set to a value of a valley around the peak. In the present embodiment, it was set to +11.9 cm⁻¹ relative to the position where the Cu₂O peak has maximum intensity. The range of wavenumbers over which the peak areas of the Cu₂O peaks are measured is set at the beginning, one time, in the measurement within the 88×60 μm measurement range as shown in FIG. 3A. Additionally, as an analysis software to measure the peak areas of the Cu₂O peaks, RAMAN Viewer Nanophoton corp Ver. 4.5.54.29507 was used.

For example, the peak areas of the Cu₂O peaks in the Raman spectra illustrated in FIG. 4 are 96.3 (upper Raman spectrum) and 49.4 (lower Raman spectrum).

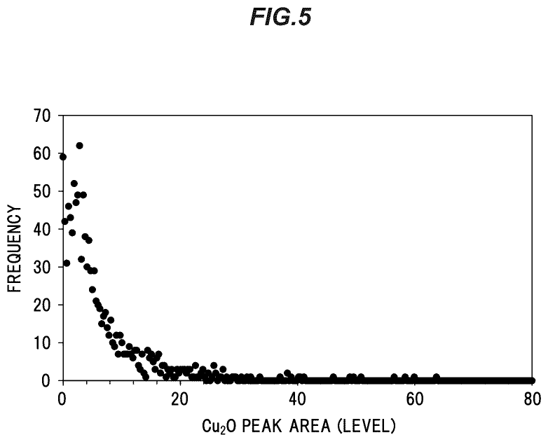

After obtaining the peak areas of the Cu₂O peaks in respective pixels of the mapping image, create a histogram with the horizontal axis representing 256 levels, into which the range from the minimum to the maximum peak areas of the Cu₂O peaks in respective pixels of the mapping image are divided, and the vertical axis representing the frequency, the number of pixels in each level. Then, the average value of the peak areas of the peaks is obtained from the created histogram, and this is obtained as the oxidation degree. FIG. 5 shows a histogram of a mapping image containing the Raman spectrum of FIG. 4 as an example of a histogram.

### (Evaluation of the Peeled Material)

Below are the results of an experimental evaluation of the oxidation degree of the peeled material.

As the first evaluation, the relationship between the oxidation degree on the surface of the peeled material and the oxidation state as judged by the discoloration of the surface was evaluated. In this evaluation, the oxidation degree was measured by the method described above and the presence or absence of discoloration was determined by observation of the appearance of the peeled copper-based material, which was stored under various storage conditions (temperature of 10 to 45° C., humidity of 50 to 95% RH, and time of 4 to 48 hours). In this evaluation, a peeling material of 6.3 mm in diameter and approximately 5 cm in length was used which was stored in a constant temperature and humidity chamber.

Table 1 below shows the numerical values of the oxidation degree (average peak area of Cu₂O peaks) for each storage condition of the peeled material determined by the experiment. For those pieces for which surface discoloration was visually observed, “discoloration” was written under the numerical values of oxidation degree.

TABLE 1

| | | Storage Temperature × Storage Humidity | | | | | | |
|---|---|---|---|---|---|---|---|---|
| | | 10° C. × | 20° C. × | 25° C. × | 30° C. × | 35° C. × | 40° C. × | 45° C. × |
| | | 50% RH | 95% RH | 95% RH | 95% RH | 95% RH | 95% RH | 95% RH |
| Storage | 0 | 3.35 | 3.35 | 3.35 | 3.35 | 3.35 | 3.35 | 3.35 |
| Time | 4 | 7.39 | 8.54 | 5.51 | 11.27 | 1.26 | 9.09 | 133.7 |
| (h) | | | | | | | | (discoloration) |
| | 12 | 2.76 | 3 13 | 13 1 | 2.76 | 4.21 | 21.84 | 183.7 |
| | | | | | | | | (discoloration) |
| | 24 | 8.79 | 9.89 | 3 11 | 2.6 | 14.46 | 8 14 | 102.6 |
| | | | | | | | | (discoloration) |
| | 48 | 9.94 | 14.96 | 3.82 | 2 15 | 11.74 | 10.53 | 192.2 |
| | | | | | | | | (discoloration) |

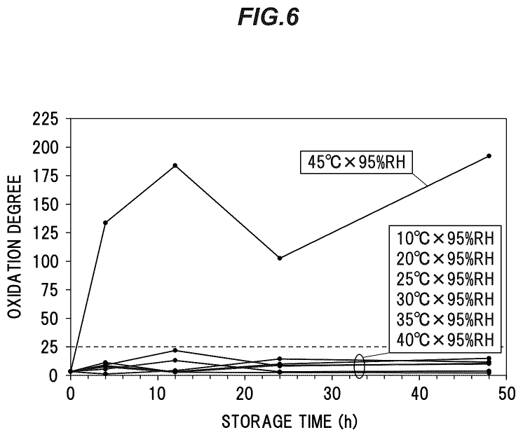

FIG. 6 is a graph plotting the data from Table 1 with the horizontal axis representing the storage time of the peeled material (h) and the vertical axis representing the oxidation degree. According to the results shown in Table 1 and FIG. 6, the oxidation on the surface of the peeled material can be suppressed when the oxidation degree is approximately less than 25, and also, the oxidation on the surface of the peeled material can be suppressed when the peeled material is stored under the conditions where the temperature is 40° C. or less, the humidity is 95% RH or less, and the storage time is 48 hours or less.

The peeled material shown in FIG. 1A is a peeled material included in Table 1, which was stored under conditions where the temperature is 40° C., the humidity is 95% RH, and the storage time is 12 hours. The peeled material shown in FIG. 1B is a peeled material included in Table 1, which was stored under conditions where the temperature is 45° C., the humidity is 95% RH, and the storage time is 24 hours.

Next, as the second evaluation, the relationship between the oxidation degree on the surface of the peeled material, the oxidation state judged by the discoloration on the surface, and the wear mass of the peeled material during wire drawing was evaluated. In this evaluation, the measurement of the oxidation degree by the method described above, determination of the presence or absence of discoloration by observing the appearance, and measurement of the mass of wear particles after wire drawing were performed on copper-based peeled materials stored under various storage conditions (temperature of 50° C., humidity of 10 to 22% RH, and time of 48 hours to 3 weeks).

In this evaluation, a peeled material of 6.3 mm in diameter and approximately 9 m in length was used, which was kept in a thermostatic chamber in a wound state with a winding diameter of 1.09 m. The peeled material was cut into approximately 5 cm lengths and subjected to Raman scattering mapping in the oxidation degree measurement. For wire drawing, the peeled material, approximately 9 m in length, was mounted on a single-head drawing machine and drawn using a drawing die with a die hole diameter of 5.33 mm. After drawing the peeled material, wear particles from the peeled material adhering to the die were removed using ethanol and tweezers, dried at 45° C. for 24 hours to evaporate the ethanol, and the mass of the wear particles was measured using an electronic balance. This mass measurement was performed three times, and the average value of the obtained measurements was used as the mass of the peeled material worn during wire drawing (mg/9 m).

Table 2 below shows the storage conditions, the values of the oxidation degree (average peak area of Cu₂O peaks), the presence or absence of surface discoloration as judged visually, and the mass of wear particles during wire drawing of four peeled materials (referred to as samples A through D) on which the evaluation was performed. The storage condition of Sample A, “no storage,” means that Sample A is a peeled material immediately after the oxide film has been peeled and was not stored in a thermostatic chamber. The storage humidity of Samples B to D varied in the range of 10 to 22% RH due to variations in humidity at different locations inside the large thermostatic chamber.

TABLE 2

| Sample No. | A | B | C | D |
|---|---|---|---|---|
| Storage Conditions | No | 50° C., | 50° C., | 50° C., |
| (temperature, time, | Storage | 48 h 10 to | 1 week 10 | 3 week 10 s |
| humidity) | | 22% RH | to 22% RH | to 22% RH |
| Oxidation Degree | 10.02 | 10.51 | 129.24 | 23.89 |
| Discoloration | None | None | Present | None |
| Wear Mass | 0.2 | 0.5 | 11 | 0.0 |
| During Wire Drawing | | | | |
| (mg/9 m) | | | | |

According to the results shown in Table 2, the oxidation was more suppressed in Sample D than in Sample C, but Sample D should normally be more oxidized than Sample C judging from the storage conditions. This is thought to be due to the fact that samples B-D were stored in a large thermostatic chamber with large variations in humidity from place to place, and the humidity around the area where the oxidation degree was actually measured and the discoloration was observed varied among samples B-D. Therefore, among the results included in Table 2, the relationship between storage conditions and evaluation results (oxidation degree, presence or absence of discoloration, and wear mass during wire drawing) in samples B to D were determined to be unreliable and cannot be used as evaluation material.

On the other hand, according to the relationship of the oxidation degree, presence or absence of discoloration, and wear mass during wire drawing among Samples A to D, the surface oxidation is suppressed in Samples A, B, and D where the oxidation degree is less than 25 and the amount of wear during wire drawing is low, indicating that the generation of wear particles is low. If the amount of wear particles generated is low, the appearance defects of enameled wire due to foaming of microbubbles contained in the wear particles adhered to the surface of the peeled material during firing after enamel coating can be suppressed.

### (Manufacturing the Enameled Wire)

According to the present embodiment, an enameled wire can be produced using wire rod such as peeled material whose oxidation degree is evaluated using the evaluation method described above.

In other words, according to the present embodiment, it is possible to provide a method for manufacturing an enameled wire, comprising:
a mapping process in which a laser beam is irradiated on the surface of a wire rod mainly composed of copper and a Raman spectrum (spectra) is mapped;
an evaluation process in which a histogram of peak areas of peaks attributed to the lattice vibration of the Cu₂O vibration mode 2Eᵤ in respective pixels of the mapping image obtained by the mapping process is created, and the oxidation degree is evaluated by using an average value of the peak areas of peaks;
a wire drawing process in which the wire rod is drawn after the evaluation process; and
a coating forming process in which an insulative coating is formed around the conductor by applying enamel varnish to the surface of the conductor formed by drawing the wire rod and baking it.

In this method of manufacturing an enameled wire, the wire drawing process and the coating forming process are performed when the evaluation process yields a predetermined result. For example, as mentioned above, it is preferable that the oxidation degree on the surface of the wire rod be less than 25, so the wire drawing process and the coating forming process are performed when the evaluation process yields the result that the oxidation degree of the wire rod surface is less than 25.

For example, the mapping in the mapping process is performed using a Raman measurement device (RAMANforce Standard VIS-NIR-HS by Nanophoton), in the conditions where the laser wavelength is 532.06 nm, the width of the incident slit of the spectrometer is 50 μm, the ratio of the light intensity after attenuation to the maximum laser light intensity (attenuation ratio) of the ND filter is 215/255, the number of engraved lines of the grating is 600 gr/mm, the objective lens magnification and numerical aperture (NA) are 100× and 0.9 respectively, and the mapping range and pixel size are 88×60 μm and 2×2 μm respectively. When a histogram created in the evaluation process has the horizontal axis representing 256 levels in the range from the minimum to the maximum peak areas and the vertical axis representing the number of pixels in each level, and if the average value of the peak areas of the peaks obtained from the histogram is less than 25, the wire drawing process and the coating forming process are performed.

The techniques used in conventional enameled wire manufacturing methods may be used to draw the wire rod in the wire drawing process and form the insulative coating in the coating forming process. In addition to the wire drawing process, a rolling process in which a round wire rod is rolled to form a flat wire may be performed.

### Effect of the Embodiment

According to the embodiment, the use of the mapping process of Raman scattering can clarify the storage conditions for wire rods such as peeled materials, for which oxidation on the surface can be suppressed, and thus, appropriate storage conditions can be set, and a wire rod(s) with suppressed oxidation can be selected by measuring the oxidation degree on the surface. This makes it possible to provide a wire rod(s) with suppressed surface oxidation that can form a high-quality enameled wire(s) and an enameled wire(s) formed using the wire rod(s).

### SUMMARY OF THE EMBODIMENT

Next, technical ideas understood from the above embodiment, will be described with reference to the reference numerals and the like used in the embodiment. However, each reference numeral in the following description does not limit the constituent elements in the scope of claims to the members and the like specifically shown in the embodiments.

According to the first feature, a wire rod 1 is mainly composed of copper, wherein the oxidation degree measured on the surface of the wire rod using Raman spectroscopic analysis is less than 25, wherein the oxidation degree is measured by performing a Raman spectral mapping process under the conditions described below, wherein a histogram from the peak areas of the Raman spectral peaks in respective pixels of the obtained mapping image is created, an average value of a plurality of Raman spectral peaks is determined from the histogram, and a measurement is performed with the average value as the oxidation degree, wherein the plurality of Raman spectral peaks are attributed to the lattice vibration of Cu₂O vibration mode 2Eᵤ, and wherein the histogram has the horizontal axis representing 256 levels into which the range from the minimum to the maximum of the plurality of peak areas are divided and the vertical axis representing the frequency, which is the number of pixels in each level, wherein Raman measurement system is RAMANforce Standard VIS-NIR-HS by Nanophoton, the laser wavelength is 532.06 nm, a width of the incident slit of the spectrometer is 50 μm, the ratio of light intensity after attenuation to maximum laser light intensity of ND filter (attenuation ratio) is 215/255, the number of engraved lines in diffraction grating is 600 gr/mm, the magnification of objective lens is 100×, the numerical aperture (NA) is 0.9, the mapping range is 88×60 μm, and pixel size is 2×2 μm.

According to the second feature, an enameled wire 100 includes a conductor 10 made by drawing a wire rod 1 as described by the first feature and an insulative coating 11 provided around the conductor 10.

According to the third feature, a method for manufacturing an enameled wire 100, includes a wire drawing process for drawing the wire rod 1 as described by the first feature; and a coating process for forming an insulative coating 11 around the conductor 10 by applying enamel varnish to the surface of the conductor 10 formed by drawing the wire rod 1 and baking it, which is performed after the wire drawing process.

According to the fourth feature, the method for manufacturing an enameled wire 100 includes a mapping process in which a laser beam is irradiated on the surface of a wire rod 1 mainly composed of copper and a Raman spectrum is mapped; an evaluation process in which a histogram of the peak areas of the peaks attributed to the lattice vibration of the Cu₂O vibration mode 2Eᵤ in the respective pixels of the mapping image obtained by the mapping process is created, and the oxidation degree on the surface of the wire rod 1 is evaluated by using an average value of the peak areas of peaks obtained by the histogram; a wire drawing process in which the wire rod 1 is drawn after the evaluation process; and a coating forming process in which an insulative coating 11 is formed around the conductor 10 by applying enamel varnish to the surface of the conductor 10 formed by drawing the wire rod 1 and baking it, which is performed after the wire drawing process, wherein the wire drawing process and the coating forming process are performed when a predetermined result is obtained in the evaluation process.

According to the fifth feature, in the method for manufacturing the enameled wire 100 as described by the fourth feature, the mapping in the above-mentioned mapping process is performed using a Raman measurement device (RAMANforce Standard VIS-NIR-HS by Nanophoton) under the conditions where the laser wavelength is 532.06 nm, the width of the incident slit of the spectrometer is 50 μm, the ratio of the light intensity after attenuation to the maximum laser light intensity (attenuation ratio) of the ND filter is 215/255, the number of engraved lines of the grating is 600 gr/mm, the objective lens magnification and numerical aperture (NA) are 100× and 0.9 respectively, and the mapping range and pixel size are 88×60 μm and 2×2 μm, respectively, wherein the histogram created in the evaluation process has a horizontal axis representing 256 levels into which the range from the minimum to the maximum peak areas are divided and a vertical axis representing the frequency, the number of pixels in each level, and wherein the wire drawing process and the coating forming process are performed when the average value of the peak area obtained from the histogram is less than 25 in the evaluation process.

That is all for the description of the embodiment of the present invention. This invention is not limited to the above embodiment, but various modifications can be made without departing from the scope and spirit of the invention. Also, the embodiment does not limit the invention according to the scope of claims. Additionally, it should be noted that not all combinations of features are essential to the means for solving problems of the invention.

1. A wire rod mainly composed of copper,
wherein oxidation degree measured on a surface of the wire rod using Raman spectral analysis is less than 25,
wherein measurement of the oxidation degree is performed by mapping Raman spectra under conditions described below, a histogram is created from peak areas of Raman spectral peaks in respective pixels of an obtained mapping image, an average value of a plurality of the peak areas is determined from the histogram, and the average value is measured as the oxidation degree,
wherein a plurality of the Raman spectral peaks are peaks attributed to a lattice vibration of a vibrational mode 2Eᵤ of Cu₂O, and
wherein the histogram has a horizontal axis representing 256 levels into which a range from minimum to maximum of the plurality of the peak areas are divided, and a vertical axis representing a frequency, which is a number of pixels in each level,
wherein Raman measurement system is RAMANforce Standard VIS-NIR-HS by Nanophoton, a laser wavelength is 532.06 nm, a width of an incident slit of a spectrometer is 50 μm, a ratio of light intensity after attenuation to maximum laser light intensity of ND filter (attenuation ratio) is 215/255, a number of engraved lines in diffraction grating is 600 gr/mm, a magnification of objective lens is 100×, a numerical aperture (NA) is 0.9, a mapping range is 88×60 μm, and a pixel size is 2×2 μm.

2. An enameled wire, comprising:
a conductor formed by drawing a wire rod according to claim 1, and
an insulative coating formed around the conductor.

3. A method for manufacturing an enameled wire, comprising:
drawing the wire rod according to claim 1; and
forming an insulative coating around a conductor after the drawing, by applying an enamel varnish to a surface of the conductor formed by drawing the wire rod and baking the enamel varnish.

4. A method for manufacturing an enameled wire, comprising:
mapping Raman spectrum by irradiating a laser beam on a surface of a wire rod mainly composed of copper;
evaluating an oxidation degree on the surface of the wire rod by using an average value of peak areas of peaks obtained by a histogram of the peak areas of the peaks attributed to a lattice vibration of a Cu₂O vibration mode 2Eᵤ in respective pixels of a mapping image obtained by the mapping;
drawing the wire rod after the evaluation; and
forming an insulative coating around a conductor after the drawing, by applying an enamel varnish to a surface of the conductor formed by drawing the wire rod and baking the enamel varnish,
wherein the drawing and the coating forming are performed when a predetermined result is obtained in the evaluation.

5. The method for manufacturing an enameled wire, according to claim 4,
wherein the Raman spectrum mapping is performed using a Raman measurement device of RAMANforce Standard VIS-NIR-HS by Nanophoton under conditions where a laser wavelength is 532.06 nm, a width of an incident slit of a spectrometer is 50 μm, a ratio of a light intensity after attenuation to a maximum laser light intensity (attenuation ratio) of an ND filter is 215/255, a number of engraved lines of a diffraction grating is 600 gr/mm, an objective lens magnification and a numerical aperture (NA) are 100× and 0.9 respectively, and a mapping range and a pixel size are 88×60 μm and 2×2 μm respectively,
wherein the histogram created in the evaluation has a horizontal axis representing 256 levels into which a range from minimum to maximum peak areas are divided and a vertical axis representing a frequency, a number of pixels in each level, and
wherein the drawing and the coating forming are performed when an average value of the peak area obtained from the histogram is less than 25 in the evaluation.
